(19) United States
(12) Patent Application Publication
(10) Pub. No.: US 2010/0042927 A1
(43) Pub. Date: Feb. 18, 2010

(54) Third Party Management of Computer System Control

(76) Inventor: Steven D. Kim, Agoura Hills, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/604,687

(22) Filed: Oct. 23, 2009

Related U.S. Application Data
(63) Continuation of application No. 09/620,799, filed on Jul. 21, 2000, now abandoned.
(60) Provisional application No. 60/215,725, filed on Jul. 3, 2000.

(51) Int. Cl. G06F 15/177; G06F 3/048

(52) U.S. Cl. 715/735

(57) ABSTRACT

Systems and methods for configuring Internet resources are disclosed. One method comprises: providing, to a user of web hosting services, a user control panel; and providing, to a reseller of the services, a reseller control panel. Through the user control panel, the user configures an Internet resource hosted by the web hosting provider for the user. Through the reseller control panel, the reseller defines content on the user control panel. Another method allows configuring an Internet resource hosted by a web hosting provider of an Internet service to a user. This method comprises: providing a reseller control panel, through which a reseller defines content on a user control panel. This method also comprises: generating the user control panel through which a user configures the Internet resource. The Internet resource is associated with the user and used by a program executing on a server operated by the web hosting provider.

### CROSS REFERENCE TO RELATED APPLICATIONS

This application is a continuation of U.S. patent application Ser. No. 09/620,799, filed Jul. 21, 2000, which claims priority to U.S. Provisional Application Ser. No. 60/215,725, filed Jul. 3, 2000, both of which are incorporated by reference herein in their entirety.

### BACKGROUND

1. Field

The invention relates to computer system control, specifically to control of Internet resources such as web site.

2. Description of Related Art

Explosive growth of the Internet, and in particular e-commerce, has resulted in a dramatic increased in the rate at which companies and individuals are creating network resources such as World-Wide-Web sites, email accounts, and the like. Most companies do not have a direct connection to the Internet and thus contract with a web hosting company, or Internet service provider (ISP), to provide access to the Internet and to host the resources they wish to make available to other Internet users.

Typically a web hosting service provider may provide a wide range of e-commerce, application hosting, and connectivity services. For example, a company or individual may contract with a web hosting company to provide a specified amount of memory on a server for the company to establish and maintain its web site. In addition, the company may contract for other types of services, such as, for example, email services, secure socket layer (SSL), file transfer protocol (FTP) service, database services, and real media service allowing streaming audio and video from the company's web site.

After a customer has established an initial set of services with a web hosting service provider, the customer may wish to change the services previously arranged. For example, the customer may wish to add a feature such as real media service to its web site. Typically, when a customer wants to change the services for which he or she has contracted, a request for the desired change would be communicated to the web hosting service provider. At the web hosting service provider, a system administrator would determine if the new services are available to the requesting customer and which network servers of the web host's system should be configured to accommodate the requested configuration. The system administrator would then access the appropriate server and change the server configuration to conform to the requested change.

The notification to the web hosting service provider may be made in a variety of ways, such as by telephone or email for example. In some systems, customers of the web hosting provider are supplied with a “control panel” which comprises a series of interactive web pages that can be used to configure the customer's Internet resource automatically, within limits that are prescribed by the service provider. In some embodiments, the control panel is used to modify the content of a database that controls the server or servers which host the Internet resources. Such a system is described in detail in co-pending application Ser. No. 09/565,520, entitled System and Method for Managing Server Configurations, filed on May 5, 2000, the disclosure of which is incorporated herein by reference in its entirety.

It has also become common for a web hosting service provider to sell services to a third party that then re-sells those services directly to users. In this case, the user will still wish to perform updates and modifications to their Internet resource, but inefficiencies will result if the user must first contact the re-seller with the desired modification, with the re-seller subsequently contacting the web hosting service provider directly to implement the change. The distribution and use of Internet resources will be made more efficient with a mechanism by which the user may contact the web hosting service provider directly with changes, but which still allows re-seller control over aspects of this process.

### SUMMARY

Methods and systems for delivering and managing Internet resources are provided. In one embodiment, a method of Internet resource management comprises delivering a resource control panel to a system user from an Internet resource provider, wherein the content of the control panel has been at least in part defined by a third party separate from the system user and the Internet resource provider. In another embodiment, a method of providing distributed control over Internet resources comprises delivering a first control panel to a first party, and a second control panel to a second party. In this embodiment, the second control panel is configured to define, at least in part, the content of the first control panel. In one specific implementation of this embodiment, the second party is a re-seller of web hosting services.

In another invention embodiment, an Internet resource delivery system comprises a web hosting service provider operating a plurality of servers on which Internet resources are resident, a user of Internet resources, and a first control panel accessible to the user for configuring at least one Internet resource resident on a server operated by the web hosting service provider. The system further comprises a third party re-seller of Internet resources and a second control panel accessible to the third party re-seller of Internet resources for configuring the first control panel.

### BRIEF DESCRIPTION OF THE DRAWING

FIG. 1 is a block diagram of a system for delivering Internet resources to users in one embodiment of the invention.

FIG. 2 is a block diagram illustrating information flow between the elements of FIG. 1.

FIG. 3 is one page of a control panel which may be provided to a user for configuring a delivered Internet resource.

FIG. 4 is another page of the control panel of FIG. 3.

FIG. 5 is one page of a control panel which may be provided to a third party for configuring the content of the control panel of FIGS. 3 and 4.

FIG. 6 is another page of a control panel which may be provided to a third party for configuring the content of the control panel of FIGS. 3 and 4.

FIG. 7 is a third page of a control panel which may be provided to a third party for configuring the content of the control panel of FIGS. 3 and 4.

### DETAILED DESCRIPTION

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

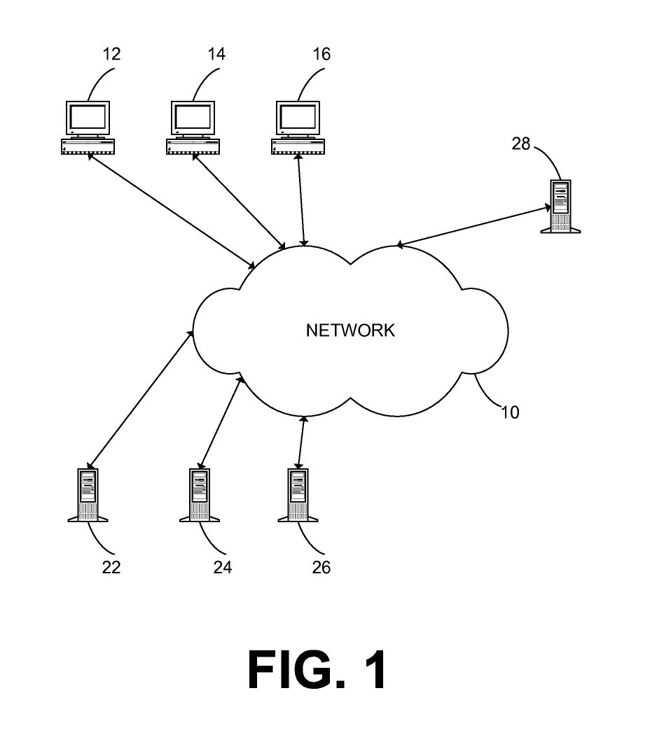

FIG. 1 shows an exemplary computer network 10 connecting one or more computing machines. The network 10 may be any type of electronically connected group of computers including, for instance, the following networks: Internet, Intranet, Local Area Networks (LAN), Wide Area Networks (WAN) or an interconnected combination of these network types. In addition, the connectivity within the network 10 may be, for example, remote modem, Ethernet (IEEE 802.3), Token Ring (IEEE 802.5), Fiber Distributed Datalink Interface (FDDI), Asynchronous Transfer Mode (ATM), or any other communication protocol. Computing devices linked to the network may be desktop, server, portable, hand-held, set-top box, personal digital assistant (PDA), a terminal, or any other desired type or configuration. Depending on their functionality, the network connected devices may vary widely in processing power, internal memory, and other performance aspects. Communications within the network and to or from the computing devices connected to the network may be either wired or wireless. Wireless communication is especially advantageous for network connected portable or hand-held devices. The network 10 may include, at least in part, the world-wide public Internet which generally connects a plurality of users in accordance with a client-server model in accordance with the transmission control protocol/Internet protocol (TCP/IP) specification. A client-server network is a dominant model for communicating between two computers. Using this relationship, a client computer (the “client”) issues one or more commands to a server computer (the “server”). The server fulfills client commands by accessing available network resources and returning information to the client pursuant to client commands. During this process, client computer systems and network resources resident on the network servers are assigned a network address for identification during communications between elements of the network. Communications from other network connected systems to the servers will include the network address of the relevant server/network resource as part of the communication so that the appropriate destination of the data/request is identified as the recipient. When the network 10 comprises the global Internet, the network address is an IP address in the TCP/IP format which may, at least in part, route data to an e-mail account, a web-site, or other Internet tool resident on the server. In this way, information and services which are resident on the network servers may be available to the web browser of a client computer through a domain name (e.g. www.site.com) which is mapped to the IP address of the network server.

As shown in FIG. 1, a plurality of clients 12, 14, and 16 are connected to the network 10 via respective communication links. Typically, each of these clients may access the network 10 via any desired form of communication, such as via a dial-up modem connection, cable link, a digital subscriber line (DSL), wireless or satellite link, or any other form of communication. Each client may communicate using any machine that is compatible with the network 10, such as a personal computer (PC), work station, dedicated terminal, personal data assistant (PDA), or other similar equipment. The clients 12, 14, and 16 may or may not be located in the same geographical area.

As shown in FIG. 1, a plurality of servers 22, 24, and 26 are connected to the network 10 to serve clients that are in communication with the network 10. Each server is typically a powerful computer or device that manages network resources and responds to client commands. As is known in the art, the servers include computer readable data storage media such as hard disk drives and RAM memory that store program instructions and data. Using such stored programs, the servers 22, 24, 26 run application programs that respond to client commands, for example, the server 22 may run a web server application for responding to client requests for HTML pages. It may also run a mail server application for receiving and routing electronic mail. Other application programs, such as an FTP server or a media server for streaming audio/video data to clients may also be running on the server 22. In some cases, different servers may be dedicated to performing different tasks. For example, the server 22 may be a dedicated web server that manages resources relating to web sites for various users, whereas the server 24 may be dedicated to provide electronic mail (email) management. Other servers may be dedicated for media (audio, video, etc.), file transfer protocol (FTP), or a combination of any two or more services that are typically available or provided over a network. Each server may be in a location that is the same as or different from that of other servers. Moreover, there may be multiple servers that perform mirrored tasks for users, thereby relieving congestion or minimizing traffic directed to and from a single server. In one embodiment of the invention, the servers 22, 24, 26 are under the control of a web hosting provider in the business of maintaining and delivering third party content over the network 10.

Web hosting providers deliver services to two different types of clients. One type, referred to herein as a “browser”, requests content from the servers 22, 24, 26 such as web pages, email messages, video clips, etc. A second type of client, referred to herein as a “user”, hires the web hosting provider to maintain a network resource such as a web site, and to make it available to browsers. Users contract with the web hosting provider to make memory space, processor capacity, and communication bandwidth available for their desired network resource, generally paying the web hosting provider in accordance with the amount of server resources the user desires to utilize.

In order for the web hosting provider to provide services for both of these clients, application programs which manage the network resources hosted by the servers must be properly configured. The program configuration process generally involves defining a set of parameters which control, at least in part, the application program's response to browser requests and which also define, at least in part, the server resources available to a particular user.

In some cases, the users do not contract directly with the web hosting service provider that operates and maintains the servers 22, 24, 26. Instead, one or more users may contract with a third party re-seller 28 of web hosting services. In these situations, the users 12, 14, 16 conduct business with the re-seller 28, and the re-seller 28 interacts with the provider that operates the servers 22, 24, 26.

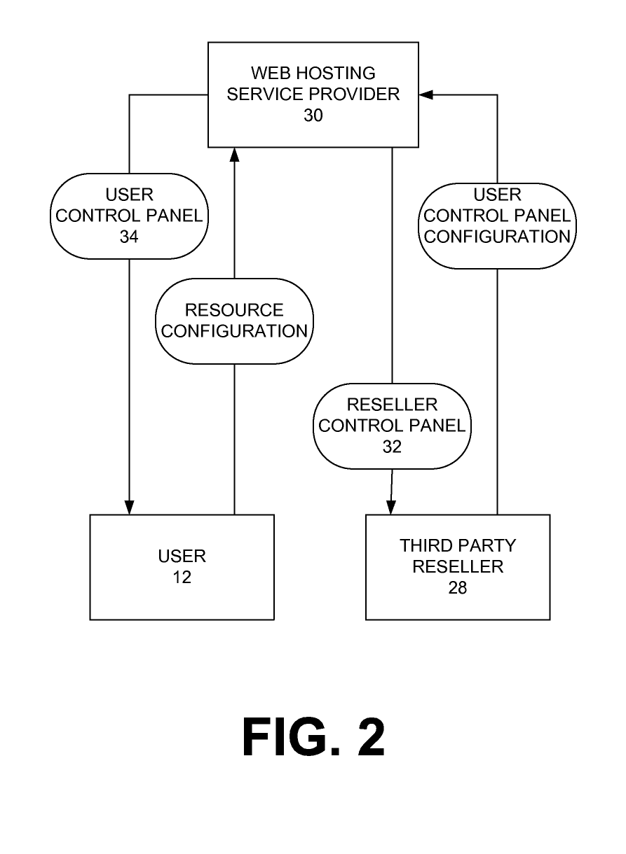

To improve the efficiency of Internet resource delivery and management, however, users are given the ability to interface directly with the web hosting service provider in a transparent manner that maintains control of the relationship in the re-sellers hands. This is illustrated in FIG. 2.

Referring now to FIG. 2, the re-seller 28 is provided with a control panel 32. The control panel may, for example, comprise a series of linked interactive HTML pages that the re-seller uses to provide information to the web hosting service provider 30. In addition, the user 12 is also provided with a control panel 34 that the user 12 uses to provide information to the web hosting service provider 30. Specifically, the user 12 may use the control panel 34 to provide information to the web hosting service provider 30 regarding desired configurations of the Internet resource that they have maintained on one or more of the servers 22, 24, 26. In one embodiment, the user control panel 34 is used to update the server configuration database described in the co-pending application Ser. No. 09/565,520 mentioned above. With this system, therefore, the user 12 is allowed direct and in some cases essentially instant access to the configuration of their Internet resources.

Depending on the nature of the relationship or contract between the user 12 and the third party 28, however, the third party 28 may wish to have control over what configurations the user may select, upgrade, or otherwise alter. The third party 28 may also wish to control the format in which the user control panel displays the available options. To accomplish this, the re-seller control panel 32 may be used to define, at least in part, the content of the user control panel 34. Thus, user control panel configuration information is transmitted to the web hosting service provider 30. Based on this information, the web hosting service provider configures the control panel 34 that is displayed to the user 12.

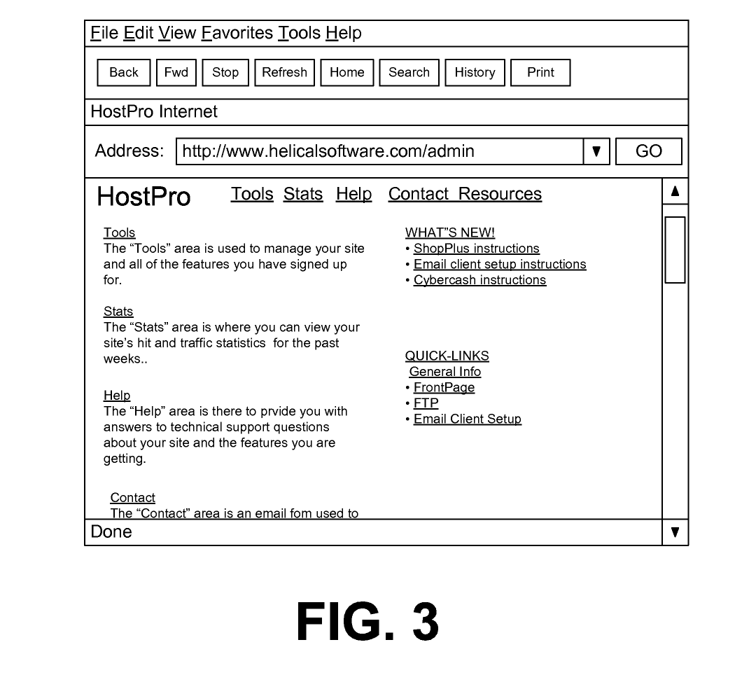

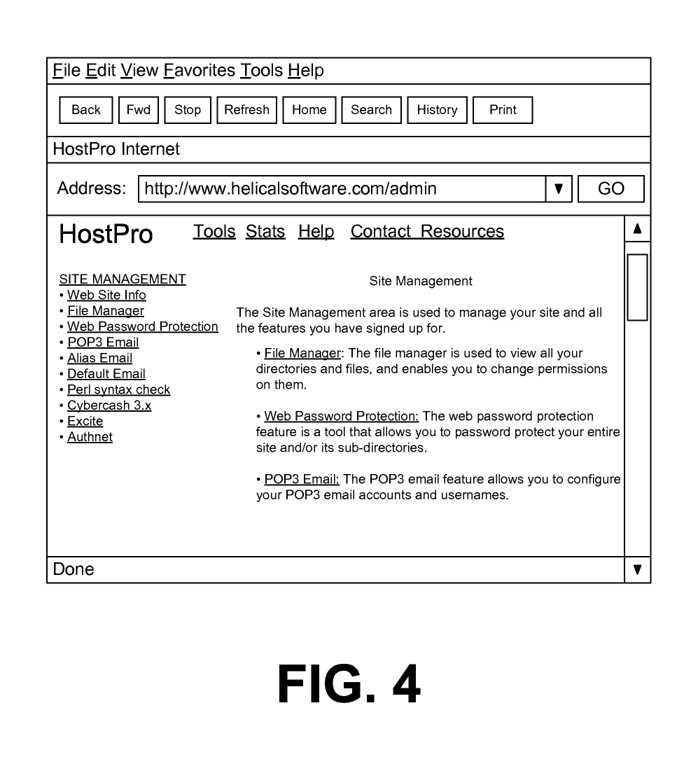

FIG. 3 is an illustration of one embodiment of an HTML page that may be provided as part of a user control panel 34. The page illustrated in FIG. 3 includes links 40 to additional interactive pages that allow the user 12 to configure their Internet resource. Clicking on the “TOOLS” link, for example, will retrieve the page illustrated in FIG. 4.

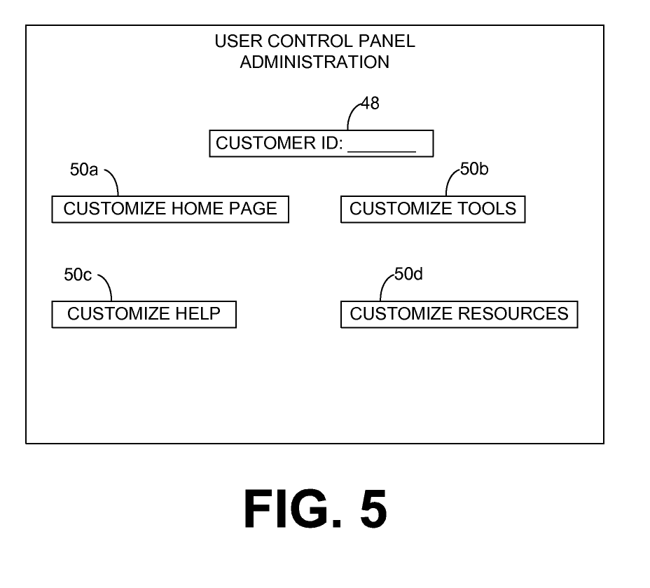

FIG. 5 is an illustration of an HTML page that may form part of a third party re-seller control panel 32. This page may include a field 48 for identifying the user 12 whose control panel 34 is being configured. The reseller control panel page may also include links 50a, 50b, 50c, 50d that retrieve additional HTML pages that allow the re-seller to configure the format and content of various pages of the user control panel 34. In the embodiment of FIGS. 3-5, the CUSTOMIZE HOME PAGE option may be used to configure the user control panel page of FIG. 3. The CUSTOMIZE TOOLS option may be used to configure the user control panel page of FIG. 4.

A variety of options may be provided to the third party re-seller with respect to defining the user control panel 34. The re-seller may, for example, be able to define any company logos or art work that appear on the user control panel 34. The re-seller may further define the positioning or format of the text of the user control panel 34. In addition, the re-seller may be allowed to add new HTML pages or provide additional links on the user control panel.

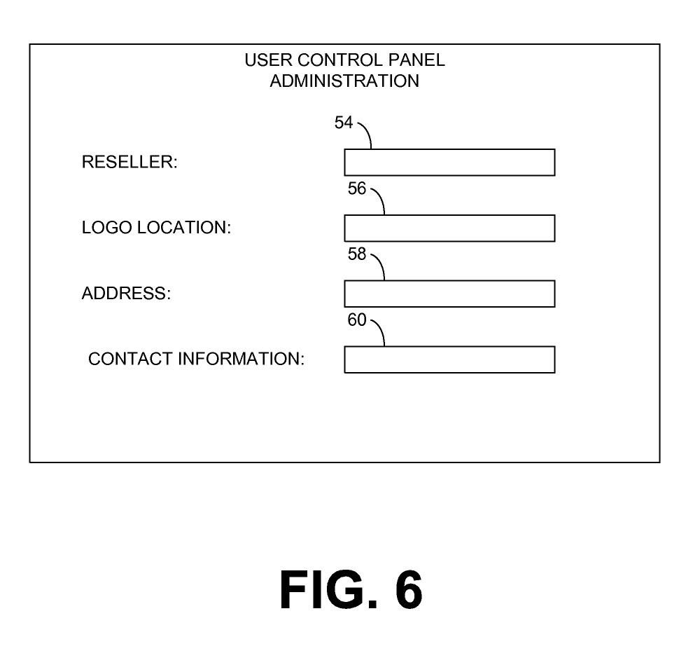

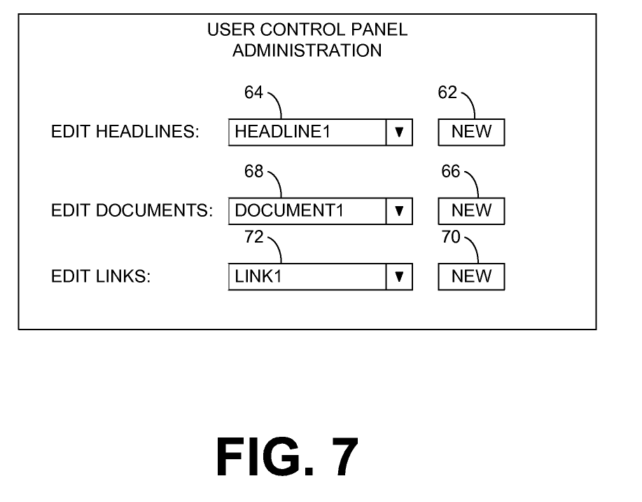

Some of these options are illustrated in the re-seller control panel pages illustrated in FIGS. 6 and 7. With the page of FIG. 6, the re-seller may enter information related to re-seller identity. This page may include several fields. A field 54 is used to enter the re-seller name. Another field 56 may be provided to specify the location (a URL, for example) that contains the re-seller logo or art work. Additional fields 58, 60 can be used to enter the re-seller address and other contact information. In some embodiments, this information is made to appear on the home page of the user control panel (e.g. FIG. 3 described above) such that as far as the user is aware, the re-seller is the direct provider of the web hosting services that are supplied to the user and that are configured with the user control panel.

With the re-seller control panel page illustrated in FIG. 7, a re-seller may be allowed to create and modify HTML documents, text headlines, and links that are part of, or available from, a user control panel. For example, with button 62 or field 64, a new headline may be created or an existing headline modified. Headlines comprise text that advantageously appears displayed in its entirety on the home page of the user control panel. This is useful for displaying current news items or important information the re-seller would like to present to the users. Button 66 and field 68 may allow the creation and modification of documents available to the user. These documents may, for example, comprise added HTML pages that are available to the user via an existing control panel page. In addition, links to other Internet sites or resources which are available on the user control panel may be defined and/or modified with button 70 and field 72.

As described above, the re-seller may also be allowed to define the options for Internet resource configuration that are made available to the user through the user control panel 34.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A method comprising:
providing, to a user of services that are provided by a web hosting provider, a user control panel through which the user configures an Internet resource hosted by the web hosting provider and made available to the user; and
providing, to a reseller of the web hosting services to the user, a reseller control panel through which the reseller defines, at least in part, content on the user control panel.

2. The method of claim 1, wherein the Internet resource is selected from the group consisting of website, electronic mail, file, and media stream.

3. The method of claim 1, the user control panel being used to configure a capacity of the Internet resource.

4. The method of claim 1, the user control panel supporting configuration of a resource parameter which includes at least one of memory space, processor capacity, and communication bandwidth.

5. A method of configuring an Internet resource hosted by a web hosting provider, the web hosting provider providing an Internet service to a user, the method comprising:
providing a reseller control panel through which a reseller of the Internet service defines at least a portion of content on a user control panel; and
generating the user control panel through which a user configures the Internet resource, the Internet resource being associated with the user and used by a program executing on a server operated by the web hosting provider.

6. The method of claim 5, wherein the program is a web server, a mail server, a media server, an FTP server, or a combination thereof.

7. The method of claim 5, the reseller control panel being used to control which graphics are displayed on the user control panel.

8. The method of claim 5, the reseller control panel being used to control the format of text on the user control panel, the positioning of text on the user control panel, or a combination thereof.

9. A method of configuring a web site hosted by a web host on behalf of a user, the method comprising:
providing a user control panel through which the user configures the web site; and
providing a reseller control panel through which a reseller for the web host modifies content on the user control panel.

10. The method of claim 9, the user control panel including a series of linked web pages resident on a server that is operated by the web hosting provider.

11. The method of claim 9, the reseller control panel including a series of linked web pages resident on a server that is operated by the web hosting provider.

12. The method of claim 9, the reseller control panel supporting configuration of format of text on the user control panel, positioning of text on the user control panel, or a combination thereof.

13. A method of configuring an Internet resource, the method comprising:
providing a user control panel through which a user configures a parameter that controls availability of the Internet resource to the user; and
providing a reseller control panel through which a reseller of the Internet service modifies content on the user control panel.

14. The method of claim 13, wherein the Internet resource is selected from the group consisting of website, electronic mail, file, and media stream.

15. The method of claim 13, wherein the parameter controls availability of memory space, processor capacity, communication bandwidth, or a combination thereof.

16. The method of claim 13, the reseller control panel being used to control the format of text on the user control panel, the positioning of text on the user control panel, or a combination thereof.

17. A method of configuring an Internet resource, the method comprising:
hosting an Internet resource on a server configured to execute a program, the program making the Internet resource available to a customer of an entity that operates the server;
delivering, to the user, a user control panel to the user through which the user configures availability of the Internet resource to the user; and
delivering, to a reseller of the hosted Internet resource, a reseller control panel through which the reseller defines, at least in part, the content of the user control panel.

18. The method of claim 17, wherein the program is a web server, a mail server, a media server, an FTP server, or a combination thereof.

19. The method of claim 17, the reseller control panel being used to configure at least one configuration option for the program, the configuration option available on the user control panel.

20. The method of claim 17, the reseller control panel being used to control the format of text on the user control panel, the positioning of text on the user control panel, or a combination thereof.
